(19) United States
(12) Patent Application Publication
(10) Pub. No.: US 2025/0050211 A1
(43) Pub. Date: Feb. 13, 2025

(54) METHOD AND APPARATUS FOR DISPLAYING INTERFACE FOR VIRTUAL GAME, DEVICE, MEDIUM, AND PROGRAM PRODUCT

(71) Applicant: TENCENT TECHNOLOGY (SHENZHEN) COMPANY LIMITED, Shenzhen (CN)

(72) Inventor: Ye KUANG, Shenzhen (CN)

(21) Appl. No.: 18/928,291

(22) Filed: Oct. 28, 2024

Related U.S. Application Data
(63) Continuation of application No. PCT/CN2023/119625, filed on Sep. 19, 2023.

(30) Foreign Application Priority Data
Nov. 15, 2022 (CN) 202211428461.X

(51) Int. Cl. A63F 13/52; A63F 13/55

(52) U.S. Cl. CPC A63F 13/52; A63F 13/55

(57) ABSTRACT

An method for displaying an interface includes: displaying a game interface corresponding to a turn-based virtual game, the turn-based virtual game comprising a plurality of rounds, each round comprising a plurality of stages, and the game interface comprising a stage progress bar; displaying, in an i^{th} stage of a game round, a first update animation of the stage progress bar in a first update direction based on stage progress of the i^{th} stage, i being a positive integer, and i being less than a quantity of stages of the game round; and displaying, in an (i+1)^{th} stage of the game round based on an update result of the stage progress bar in the i^{th} stage, a second update animation of the stage progress bar in a second update direction based on stage progress of the (i+1)^{th} stage, the first update direction and the second update direction being two opposite directions.

### RELATED APPLICATIONS

This application is a continuation of PCT Application No. PCT/CN2023/119625, filed on Sep. 19, 2023, which claims priority to Chinese Patent Application No. 202211428461.X, filed on Nov. 15, 2022, and entitled “METHOD FOR DISPLAYING AN INTERFACE AND APPARATUS FOR VIRTUAL GAME, DEVICE, AND MEDIUM”, which are incorporated herein by reference in their entirety.

### FIELD OF THE TECHNOLOGY

This application relates to the field of animation generation, and in particular, to an method for displaying an interface and apparatus for a virtual game, a device, a medium, and a program product.

### BACKGROUND OF THE DISCLOSURE

In a turn-based virtual game, based on a selection operation on a virtual object configured by a player in a virtual game, the virtual object can be automatically controlled for the game, and the game result is displayed.

Often a progress bar is set for each game stage in the turn-based virtual game. When a corresponding game stage is reached, a corresponding progress bar is called to show a progression. For example, a single round game of auto chess includes scene switching, field refresh, a preparation stage, chess piece position locking, and transmission to a target chessboard, and five progress bars are configured for five game stages. When the game stage “scene switching” is entered, a corresponding progress bar is called to play the animation.

However, when a game process of the turn-based virtual game is implemented in the foregoing manner, the progress bar continuously jumps with progress of the game stage. As a result, a user cannot have a clear perception on the change of the current progress bar, and less effective game information can be obtained from the progress bar, which reduces human-computer interaction efficiency to a certain extent.

### SUMMARY

Embodiments of the present application provide a method, device, equipment, medium and program product for displaying a virtual game interface, which can improve the interface expressiveness of the stage progress bar while improving the efficiency of users obtaining effective information from the stage progress bar. The technical solution is as follows.

According to one aspect, an method for displaying an interface for a virtual game is provided. The method includes: displaying a game interface corresponding to a turn-based virtual game, the turn-based virtual game comprising a plurality of rounds, each round comprising a plurality of stages, and the game interface comprising a stage progress bar; displaying, in an i^{th} stage of a game round, a first update animation of the stage progress bar in a first update direction based on stage progress of the i^{th} stage, i being a positive integer, and i being less than a quantity of stages of the game round; and displaying, in an (i+1)^{th} stage of the game round based on an update result of the stage progress bar in the i^{th} stage, a second update animation of the stage progress bar in a second update direction based on stage progress of the (i+1)^{th} stage, the first update direction and the second update direction being two opposite directions.

According to another aspect, a computer device is provided, including a processor and a memory, the memory having at least one instruction, at least one program, and a code set or an instruction set stored therein, and the at least one instruction, the at least one program, and the code set or instruction set being loaded and executed by the processor, to implement the method for displaying an interface for a virtual game according to any one of the embodiments of this application.

According to another aspect, a non-transitory computer-readable storage medium is provided, having at least one program code stored therein, the program code being loaded and executed by a processor, to implement the method for displaying an interface for a virtual game by a terminal device according to any one of the embodiments of this application.

The technical solutions provided in this application may include the following beneficial effects:

During progress of a turn-based virtual game, progress bars corresponding to two stages with adjacent timing (e.g., one stage following another stage) in a single round indicate game progress in opposite update directions. Accordingly, remaining time of a specific stage in a game round can be clearly expressed, and progress bars of stages are smoothly connected, so that game experience of a user is enhanced when an information transmission rate of the progress bar is improved.

### BRIEF DESCRIPTION OF THE DRAWINGS

FIG. 1 is a schematic diagram of an implementation environment according to an embodiment of this application.

FIG. 2 is a flowchart of an method for displaying an interface for a virtual game according to an embodiment of this application.

FIG. 3 is a schematic diagram of a display interface of a stage progress bar according to an embodiment of this application.

FIG. 4 is a flowchart of conversion of the stage progress bar provided based on FIG. 3 according to an embodiment.

FIG. 5 is a schematic diagram of a display interface of a stage progress bar according to another embodiment of this application.

FIG. 6 is a flowchart of an method for displaying an interface for a virtual game according to another embodiment of this application.

FIG. 7 is a schematic diagram of mark display of a stage progress bar corresponding to selecting a virtual object and removing the virtual object according to an embodiment of this application.

FIG. 8 is a flowchart of an method for displaying an interface for a virtual game according to still another embodiment of this application.

FIG. 9 is a block diagram of an interface display apparatus for a virtual game according to an embodiment of this application.

FIG. 10 is a block diagram of an interface display apparatus for a virtual game according to another embodiment of this application.

FIG. 11 is a block diagram of a structure of a terminal according to an embodiment of this application.

### DESCRIPTION OF EMBODIMENTS

First, terms involved in embodiments of this application are briefly introduced.

A turn-based virtual game is a virtual game mode. In this mode, the turn-based virtual game includes a plurality of rounds, and one round includes a plurality of stages. In one round, two parties in the game take turns to perform an operation, to complete deployment of a game strategy, for example, select a virtual object for the game or arrange a position of the virtual object for the game. For example, an example in which the turn-based virtual game is an “auto chess game” is used for description, in such a virtual game, a player can automatically match a virtual object (also referred to as a “chess piece”) in a round, to form a virtual object lineup, and battle with an opposing virtual object lineup.

A virtual environment is a virtual environment displayed (or provided) when an application is run on a terminal. The virtual environment may be a simulated environment of the real world, a semi-simulated semi-fictional environment, or a purely fictional environment. The virtual environment may be any one of a two-dimensional virtual environment, a 2.5-dimensional virtual environment, and a three-dimensional virtual environment. This is not limited by the embodiments in this application. The following embodiment uses an example in which the virtual environment is the three-dimensional virtual environment for description.

A virtual object selection area is configured for indicating an area in which a player selects a virtual object for the game during progress of a turn-based virtual game. In the area, at least one virtual object is randomly displayed for selection of the player. The player may perform at least one of a game selection operation, a locking operation, a selling operation, a shuffling operation, a synthesis operation, or an upgrade operation on the displayed at least one virtual object. An example in which the turn-based virtual game is an “auto chess game” is used for description. The virtual object selection area is implemented as a game preparation area of a chessboard, and the game preparation area includes at least one game preparation square. The game preparation square is used to place a game preparation chess piece (the virtual object). The game preparation chess piece in the game preparation square does not participate in a battle, but can be dragged and placed in a battle area in a preparation stage of a round.

A virtual object is a movable object in a virtual environment. The movable object may be a virtual chess piece, a virtual character, a virtual animal, an anime character, a card, or the like, for example, a character, an animal, a plant, an oil drum, a wall, or a stone displayed in a three-dimensional virtual environment. In some embodiments, the virtual object is a three-dimensional model created based on an animation skeleton technology. Each virtual object has a shape and a volume in the three-dimensional virtual environment, and occupies a part of space in the three-dimensional virtual environment.

In the embodiments of this application, the virtual object refers to different combat units in an auto chess game. For example, the virtual object may be different chess pieces or different virtual characters. A user may perform an operation such as purchase, selling, or upgrade on the virtual object. The virtual object includes a virtual object for the game, a game preparation virtual object, and a candidate virtual object. The virtual object for the game is a chess piece placed in a battle area, the game preparation virtual object is a chess piece in a game preparation area, and the candidate virtual object is a virtual object provided to the user for obtaining in a virtual game. The user selects the game preparation virtual object from the candidate virtual object, and selects the virtual object for the game from the game preparation virtual object.

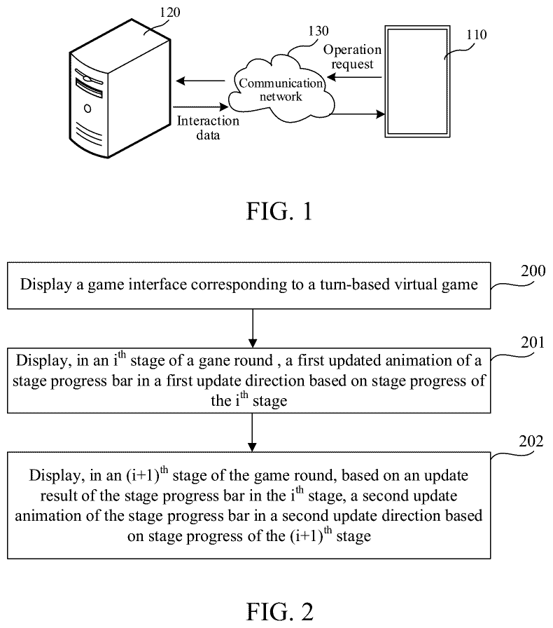

FIG. 1 is a schematic diagram of an implementation environment according to an embodiment of this application. For example, the implementation environment includes a terminal 110, a server 120, and a communication network 130.

The terminal 110 runs a target application that supports a virtual environment. The target application may be any one of a virtual reality application, a three-dimensional map program, and an auto chess game. The application may be a stand-alone application, for example, a stand-alone 3D game program. In some embodiments, the terminal 110 may be a desktop computer, a laptop portable computer, a mobile phone, a tablet computer, an e-book reader, a moving picture experts group audio layer III (MP3) player, a moving picture experts group audio layer IV (MP4) player, or the like.

The server 120 may be configured to provide a backend service for a client of the target application (for example, a game application) on the terminal 110. For example, the server 120 is a backend server of the target application (for example, the game application). The server 120 may be an independent physical server, or may be a server cluster or a distributed system formed by a plurality of physical servers, or may be a cloud server that provides basic cloud computing services such as a cloud service, a cloud database, cloud computing, a cloud function, cloud storage, a network service, cloud communication, a middleware service, a domain name service, a security service, a content delivery network (CDN), big data, and an artificial intelligence platform.

A cloud technology refers to a hosting technology that unifies a series of resources such as hardware, software, and a network in a wide area network or a local area network, to implement computing, storage, processing, and sharing of data. The cloud technology is a general name of a network technology, an information technology, an integration technology, a management platform technology, an application technology, and the like applied based on a cloud computing business mode, and may form a resource pool, which is used as required and is flexible and convenient.

In some embodiments, the server 120 may alternatively be implemented as a node in a blockchain system. A blockchain is a new application mode of computer technologies such as distributed data storage, point-to-point transmission, a consensus mechanism, and an encryption algorithm.

For example, an application corresponding to a turn-based virtual game is run on the terminal 110. During progression of the virtual game, with running of each stage in a round, a player calls a specified progress bar to play a progress update animation corresponding to a current stage. In some embodiments, in a game stage, the player may further perform an operation in the virtual game, such as selecting a virtual object or adjusting arrangement of the virtual object. The terminal generates a corresponding operation request based on the operation, and transmits the operation request to the server 120. The server calculates corresponding interaction data based on the operation request, and delivers the interaction data to the terminal 110 for display.

For example, the terminal 110 and the server 120 are connected through the communication network 130.

Information (including but not limited to user device information, user personal information, and the like), data (including but not limited to data for analysis, stored data, displayed data, and the like), and signals involved in this application are all authorized by users or fully authorized by all parties, and collection, use and processing of related data need to comply with standards of relevant laws and regulations of related countries and regions.

FIG. 2 is a flowchart of an method for displaying an interface for a virtual game according to an embodiment of this application. In this embodiment, an example in which the method is applied to the terminal shown in FIG. 1 is used for description. The method includes the following operations:

Operation 200: Display a game interface corresponding to a turn-based virtual game.

In this embodiment, a target application is run on the terminal, and the target application is a turn-based virtual game. In response to running the target application and starting the game, a game interface of the current battle is displayed in a terminal interface. The current battle includes a plurality of rounds, one round includes a plurality of stages, and the plurality of stages correspond to respective game durations. After an i^{th} stage ends, an (i+1)^{th} stage is automatically executed, i being a positive integer, and i being less than a quantity of stages of a current round. For example, the current battle includes five rounds, and one round includes four stages, namely, a stage 1, a stage 2, a stage 3 and a stage 4. The duration corresponding to the stage 1 is 1 s, duration corresponding to the stage 2 is 3 s, duration corresponding to the stage 3 is 25 s, and duration corresponding to the stage 4 is 6 s. After the 1 s duration corresponding to the stage 1 ends, the target application automatically executes a game event corresponding to the stage 2.

In some embodiments, the stage includes at least one sub-stage. A process of a merging stage may be implemented by at least one of the following methods.

In the first method, when duration of a sub-stage in the round is short, stages with adjacent time sequence and short duration are merged into one stage. For example, a single round includes four sub-stages, namely, a sub-stage 1, a sub-stage 2, a sub-stage 3, and a sub-stage 4. The duration corresponding to the sub-stage 1 is 1 s, duration corresponding to the sub-stage 2 is 3 s, duration corresponding to the sub-stage 3 is 25 s, and duration corresponding to the sub-stage 4 is 6 s. In this method, the foregoing four sub-stages are divided into three stages, namely, a stage 1 (including the sub-stage 1 and the sub-stage 2), a stage 2 (including the sub-stage 3), and a stage 3 (including the sub-stage 4).

In a second method, classification is performed based on an association degree between a sub-stage and a user. The association degree is configured for indicating whether the user participates in the sub-stage, in other words, configured for indicating whether the user generates a battle interaction event in the sub-stage. For example, a single round includes four sub-stages, namely, a sub-stage 1, a sub-stage 2, a sub-stage 3, and a sub-stage 4. The user needs to participate in and complete a game stage in the sub-stage 1 and the sub-stage 2; and the game stage may be automatically completed without participation of the user in the sub-stage 3 and sub-stage 4. In this method, the foregoing four sub-stages are divided into two stages, namely, a stage 1 (including the sub-stage 1 and the sub-stage 2) and a stage 2 (including the sub-stage 3 and the sub-stage 4).

In a third method, classification is performed based on a game event of a sub-stage. In this embodiment, the game event is divided into a game preparation event and a game execution event. The game preparation event is configured for indicating a preparation event that needs to be executed before the game event is executed, and the game execution event is configured for indicating that interaction parties in the round start the game process. In other words, all sub-stages included in a single round are divided into a game preparation stage and a game execution stage. In some embodiments, in the game preparation stage and the game execution stage, further division may be performed based on an association degree between a stage and a user. For example, the game preparation stage is divided into a pre-preparation stage and a preparation stage, and the game execution stage is divided into a pre-game stage and a game stage. The four stages further include sub-stages.

An example in which the target application is implemented as an “auto chess game application” is used for description. The single round is divided into the pre-preparation stage, the preparation stage, the pre-game stage, and the game stage. The pre-preparation stage includes four sub-stages: game settlement, transmission to a target chessboard, scene switching, and field refresh; and the pre-game stage includes two sub-stages: locking a card pool and position and transmission to the target chessboard.

In some embodiments, the game interface includes a stage progress bar. Progression of the stage progress bar is configured for indicating the execution process of a current stage.

The stage progress bar is displayed in a preset display form at a preset position in the game interface. The preset display form includes, but is not limited to, at least one of a rectangular bar, a closed circular bar, an open circular bar, a straight line graph, a curve waveform graph, or a floating image. For example, the stage progress bar is implemented as a heart-shaped circular bar. The display position of the stage progress bar is described in detail as follows.

In a first case, the stage progress bar is displayed on a peripheral side of the game interface, where the peripheral side includes an upper side of the game interface, a left side of the game interface, a right side of the game interface, and a lower side of the game interface.

In a second case, the stage progress bar is displayed on a peripheral side of the game interface in a surrounding manner. The surrounding manner may be surrounding all sides, surrounding any two adjacent two sides, or surrounding any three adjacent sides. This is not limited in this application.

In a third case, the stage progress bar is displayed in a form of a floating window at a specified position in the game interface, and a player may move the floating window corresponding to the stage progress bar during a battle. For example, when the stage progress bar is implemented as a heart-shaped circular bar, the heart-shaped circular bar is superimposed to be displayed on the game interface in a form of a floating layer, and the player moves the heart-shaped stage progress bar during the battle.

In a fourth case, during a battle, the terminal detects a blank area in the game interface, where the blank area is configured for indicating an area not occupied by another control, and the stage progress bar is adaptively displayed in the blank area.

With reference to the foregoing discussion, the single round includes the plurality of stages. The stages may share a stage progress bar, or a display quantity of stage progress bars may be set based on a quantity corresponding to a stage classification result. During display, display forms of the stage progress bars in the stages may be the same or different. In addition, display positions of the stage progress bars in the stages may be the same or different. This is not limited in this application. For example, the single round includes two stages, and there are two stage progress bars corresponding to the two stages. In a stage 1, a stage progress bar a is displayed on the upper side of the game interface in the display form of the rectangular bar, and in a stage 2, a stage progress bar b is displayed on the lower side of the game interface in the display form of the heart-shaped circular bar.

Operation 201: Display, in an i^{th} stage of a game round, a first update animation of the stage progress bar in a first update direction based on stage progress of the i^{th} stage.

As can be learned from the foregoing, the stages correspond to respective game duration, and the stage progress bar also changes correspondingly with progression of the game duration. In other words, according to game duration of each stage, an update animation corresponding to the game duration is configured. For example, game duration of the stage 1 is 25 s, and an update frequency corresponding to 25 s is determined; and a fill animation of the stage progress bar corresponding to the stage 1 is set according to the update frequency.

In response to that the current game progresses to the i^{th} stage of the game round, the first update animation of the stage progress bar is displayed in the first update direction based on game duration (the stage progress) of the i^{th} stage.

The first update direction is implemented as at least one of parallel from left to right, parallel from right to left, parallel from top to bottom, parallel from bottom to top, counterclockwise rotation, clockwise rotation, from left to right according to a preset tilt degree, from right to left according to a preset tilt degree, from top to bottom according to a preset tilt degree, from bottom to top according to a preset tilt degree, from left to right according to a preset curve trajectory, from right to left according to a preset curve trajectory, from top to bottom according to a preset curve trajectory, or from bottom to top according to a preset curve trajectory.

The first update animation is implemented as one of an animation of filling a progress bar element and an animation of reducing the progress bar element. However, both the filling the progress bar or the reducing the progress bar may be implemented as movement from one side of the progress bar to the other side, or may be implemented as movement from a center of the progress bar to two sides. This is not limited in this application.

In this embodiment, the game round includes a plurality of stages, the plurality of stages are divided into at least two stage groups, each stage group includes at least two stages, and the at least two stages include a preparatory stage and an execution stage with adjacent time sequence (which are consistent with the game preparation event and the game execution event in the foregoing content). In the preparatory stage, the first update animation of the stage progress bar is displayed in a growth direction of filling a progress bar element in the stage progress bar based on stage progress of the preparatory stage (progression of game duration of the preparatory stage).

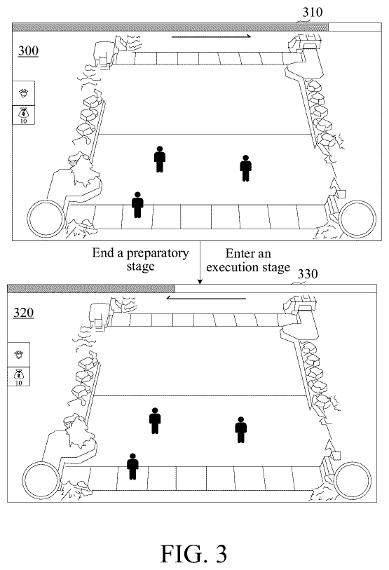

An example in which the target application is implemented as an “auto chess game application” is used for description. The game round includes eight stages, namely, game settlement, transmission to a target chessboard, scene switching, field refresh, a preparation stage, locking a card pool and position, transmission to the target chessboard, and a game stage. The eight stages are arranged based on game execution timing. The eight stages are divided into two stage groups based on an association degree between a game event and a user, namely, a game preparation stage group and a game execution stage group. The two stage groups include a preparatory stage and an execution stage, to be specific, the game preparation stage group includes a pre-preparation stage and a preparation stage, and the game execution stage group includes a pre-game stage and a game stage. The pre-preparation stage and the pre-game stage are referred to as the preparatory stage, and the preparation stage and the game stage are referred to as the execution stage. According to the foregoing content, the pre-preparation stage includes the game settlement, the transmission to a target chessboard, the scene switching, and the field refresh; and the pre-game stage includes the locking a card pool and position and the transmission to the target chessboard. As shown in FIG. 3, during progress of a game in the preparatory stage, a game interface 300 is displayed, and a stage progress bar 310 is displayed at the top of the game interface 300. With progress of the preparatory stage, a fill update animation corresponding to the stage progress bar 310 is played in an update direction from left to right. In other words, when the preparatory stage starts, the stage progress bar 310 is in an empty state, and until the preparation stage ends, the stage progress bar 310 is in a full state.

Operation 202: Display, in an (i+1)^{th} stage of the game round based on an update result of the stage progress bar in the i^{th} stage, a second update animation of the stage progress bar in a second update direction based on stage progress of the (i+1)^{th} stage.

When execution of the i^{th} stage of the game round is completed, the (i+1)^{th} stage of the game round is automatically executed. Based on the update result of the stage progress bar in the i^{th} stage, the second update animation of the stage progress bar in the second update direction is displayed based on game duration (the stage progress) of the (i+1)^{th} stage.

The second update direction is configured for indicating a direction opposite to the first update direction. In some embodiments, the second update direction may also be implemented as at least one of parallel from left to right, parallel from right to left, parallel from top to bottom, parallel from bottom to top, counterclockwise rotation, clockwise rotation, from left to right according to a preset tilt degree, from right to left according to a preset tilt degree, from top to bottom according to a preset tilt degree, from bottom to top according to a preset tilt degree, from left to right according to a preset curve trajectory, from right to left according to a preset curve trajectory, from top to bottom according to a preset curve trajectory, or from bottom to top according to a preset curve trajectory. This is not limited in this application. For example, the first update direction is parallel from left to right, and the second update direction is parallel from right to left; or the first update direction is from top to bottom according to the preset tilt degree, and the second update direction is from bottom to top according to the preset tilt degree.

In this embodiment, with reference to the foregoing content, in the execution stage, the second update animation of the stage progress bar is displayed in a direction of reducing the progress bar element in the stage progress bar based on stage progress of the execution stage by using a fill result of the stage progress bar in the preparatory stage as update starting progress in the execution stage. As shown in FIG. 3, when execution of the preparatory stage is completed and the execution stage is automatically executed in sequence, a game interface 320 is displayed, and a stage progress bar 330 displayed in the current game interface 320 is in a full state (namely, a state corresponding to the stage progress bar at an end moment of the preparatory stage). During progress of a game in the execution stage, a reduction update animation corresponding to the stage progress bar 330 is played in an update direction from right to left. In other words, when the execution stage starts, the stage progress bar 330 is in the full state, and until the execution stage ends, the stage progress bar 330 is in an empty state. In other words, update animations of the stage progress bar in different directions are respectively displayed in the preparatory stage and the execution stage, so that the user can obtain a time change status of current game progress more intuitively, thereby improving human-computer interaction efficiency.

In another embodiment, the game round includes a first stage group and a second stage group. The first stage group includes a first preparatory stage and a first execution stage, and the second stage group includes a second preparatory stage and a second execution stage.

An update animation corresponding to a stage progress bar in a first display form is displayed based on an updating process of a stage progress bar corresponding to the first stage group. An update animation corresponding to a stage progress bar in a second display form is displayed based on an updating process of a stage progress bar corresponding to the second stage group.

The display form includes at least one of a display color, a display texture, a display pattern, or display transparency of the stage progress bar. In some embodiments, when the stage progress bar includes a stage pointer, a display form of the stage pointer may also vary. For example, in response to being in a game stage corresponding to the first stage group, an orange stage progress bar is displayed; and in response to being in a game stage corresponding to the second stage group, a blue stage progress bar is displayed. In other words, when a single round includes a plurality of stage groups, update animations of corresponding progress bars are displayed in different display forms, so that the user can better obtain actual progress of different stage groups, thereby improving accuracy and efficiency of progress information indication.

In some embodiments, the stage progress bar in the first display form and the stage progress bar in the second display form mentioned above may be different display forms of a same stage progress bar, or may be implemented as two independent stage progress bars. This is not limited in this application.

With reference to the foregoing content, the first stage group and the second stage group respectively correspond to the preparatory stage and the execution stage.

In the first preparatory stage, based on stage progress of the first preparatory stage, the update animation of the stage progress bar in the first display form is displayed in a growth direction of filling a progress bar element in the stage progress bar in the first display form.

In the first execution stage, based on stage progress of the first execution stage, the update animation of the stage progress bar in the first display form is displayed in a direction of reducing the progress bar element in the stage progress bar in the first display form.

In the second preparatory stage, based on stage progress of the second preparatory stage, the update animation of the stage progress bar in the second display form is displayed in a growth direction of filling a progress bar element in the stage progress bar in the second display form.

In the second execution stage, based on stage progress of the second execution stage, the update animation of the stage progress bar in the second display form is displayed in a direction of reducing the progress bar element in the stage progress bar in the second display form.

The first preparatory stage, the first execution stage, the second preparatory stage, and the second execution stage are four stages executed in sequence.

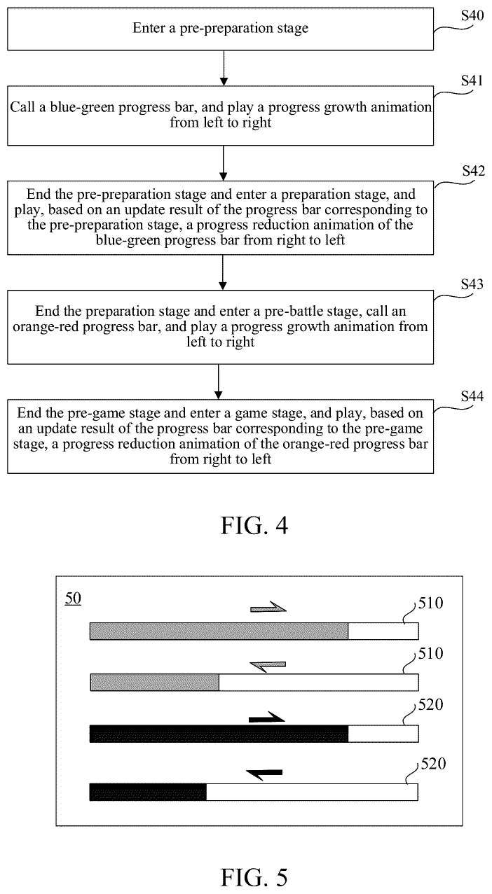

An example in which the target application is implemented as an “auto chess game application” is used for description. The game round includes four stages, and an execution process of the four stages and a display process of corresponding stage progress bars are shown in FIG. 4.

S40: Enter a pre-preparation stage. The pre-preparation stage includes game settlement, transmission to a target chessboard, scene switching, and field refresh.

S41: Call a blue-green progress bar, and play a progress growth animation from left to right. To be specific, at a starting moment of the pre-preparation stage, the blue-green progress bar is in an empty state; during the pre-preparation stage, the blue-green progress bar gradually grows from left to right; and at an ending moment of the pre-preparation stage, the blue-green progress bar is in a blue-green full state.

S42: End the pre-preparation stage and enter a preparation stage, and play, based on an update result of the progress bar corresponding to the pre-preparation stage, a progress reduction animation of the blue-green progress bar from right to left. To be specific, at a starting moment of the preparation stage, the blue-green progress bar is in the blue-green full state; during the preparation stage, the blue-green progress bar gradually reduces from left to right; and at an ending moment of the preparation stage, the blue-green progress bar is in the empty state.

S43: End the preparation stage and enter a pre-game stage, where the pre-game stage includes locking a card pool and position and transmission to a target chessboard, call an orange-red progress bar, and play a progress growth animation from left to right. To be specific, at a starting moment of the pre-game stage, the orange-red progress bar is in an empty state; during the pre-game stage, the orange-red progress bar gradually grows from left to right; and at an ending moment of the pre-game stage, the orange-red progress bar is in an orange-red full state.

S44: End the pre-game stage and enter a game stage, and play, based on an update result of the progress bar corresponding to the pre-game stage, a progress reduction animation of the orange-red progress bar from right to left. To be specific, at a starting moment of the game stage, the orange-red progress bar is in the orange-red full state; during the game stage, the orange-red progress bar gradually reduces from left to right; and at an ending moment of the game stage, the orange-red progress bar is in the empty state. As shown in FIG. 5, a progress bar display interface 50 is displayed based on the four stages shown in FIG. 4. The progress bar display interface 50 includes a first stage progress bar 510 corresponding to the pre-preparation stage, the first stage progress bar 510 corresponding to the preparation stage, a second stage progress bar 520 corresponding to the pre-game stage, and the second stage progress bar 520 corresponding to the game stage. The first stage progress bar 510 is implemented as the blue-green progress bar (refer to a gray shadow in FIG. 5), and the second stage progress bar 520 is implemented as the orange-red progress bar (refer to a black shadow in FIG. 5). It can be seen from progress update directions of stage progress bars shown in FIG. 5 that, update directions of two stages with adjacent timing are exactly opposite. In an implementation process, the pre-preparation stage and the preparation stage are packaged, and the growth (pre-preparation) and the reduction (preparation) of the same blue-green progress bar are used for identification; and the pre-game stage and the game stage are packaged, and the growth (pre-battle) and the reduction (battle) of the same orange-red progress bar are used for identification.

In the entire updating process of the progress bar, the plurality of stages in the game round are integrated into four stage groups based on an auto chess game rule, and the stage group includes at least one stage. To be specific, the pre-preparation stage is configured for indicating that the player does not need to participate in this stage to execute the game event, for example, cannot deploy a chess piece or adjust a position of a chess piece. In this stage, only the blue-green progress bar from left to right needs to be used to indicate that a stage group in which the player may execute the game event is about to be entered. The preparation stage is entered. In the preparation stage, the player may select, delete, lock, or sell a chess piece based on a requirement of the player, and adjust a position of a chess piece based on an actual situation. When a game event operation between players is generated, based on an update result of a progress bar corresponding to a previous stage, the player is warned with the update direction from right to left that adjustment time is about to end. After the pre-game stage is entered, where the pre-game stage is the same as the pre-preparation stage, the player cannot generate a game event, and the progress bar is updated in the update direction from left to right by using another orange-red progress bar, to remind the player that the game stage is about to be entered. After the pre-game stage ends and the game stage is entered, based on an update result of a progress bar corresponding to a previous stage, the player is warned with the update direction from right to left that battle time is about to end. In other words, an objective of setting two progress bars is to inform the player that there is a preparation stage for adjusting a chess piece line-up and a game stage for battling with an opposing virtual object in the game round.

In summary, according to the method for displaying an interface for a virtual game provided in the embodiments of this application, during progress of a turn-based virtual game, progress bars corresponding to two stages with adjacent timing in a single round indicate game progress in opposite update directions. Accordingly, remaining time of a specific stage in a game round can be clearly expressed, and progress bars of stages are smoothly connected, so that game experience of a user is enhanced when an information transmission rate of the progress bar is improved.

In the embodiments of this application, the user is further warned by reducing the progress bar in a stage having an association relationship with the user, thereby improving a capability of the progress bar to convey game information.

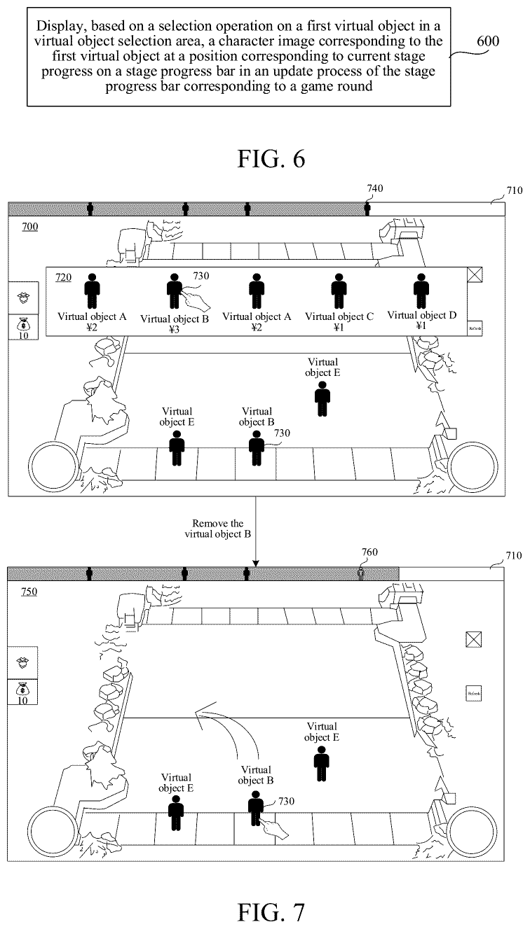

During a battle in a target application, a player needs to select a virtual object from a plurality of candidate virtual objects as a virtual object for the game in a virtual game to complete the battle. When the target application is implemented as an “auto chess game”, in an execution stage, a virtual object selection area is displayed in a game interface, and the player selects a target virtual object from the virtual object selection area for a subsequent battle. In a process in which the target virtual object is selected, this application provides an method for displaying an interface for a virtual game in which a character image of the selected target virtual object is displayed in a stage progress bar. As shown in FIG. 6, an example in which the method is applied to the terminal shown in FIG. 1 is used for description. The method includes the following operations:

Operation 600: Display, based on a selection operation on a first virtual object in the virtual object selection area, a character image corresponding to the first virtual object at a position corresponding to current stage progress on the stage progress bar in an updating process of the stage progress bar corresponding to a game round.

In some embodiments, in a preparation stage of the game round, the virtual object selection area is displayed in the game interface, and the virtual object selection area includes at least one candidate virtual object. In the virtual object selection area, a two-dimensional character image or a three-dimensional character image of the candidate virtual object is displayed. A display manner of a character image of the at least one candidate virtual object in the virtual object selection area is determined based on an autonomous setting requirement of a player.

In another embodiment, during the battle, a virtual object of a current user is automatically upgraded based on that a quantity of virtual objects selected by the player reaches a preset quantity. With an automatic upgrade process, a character image of the virtual object also changes. In other words, through the selection operation on the first virtual object, the virtual object is displayed at a corresponding progress position on the progress bar based on the virtual object obtained through selection, so that the selection operation on the virtual object can be fed back on the progress bar, thereby enriching information content of the progress bar, and improving human-computer interaction efficiency.

The updating process of the stage progress bar corresponding to the game round means that the virtual game is executed in sequence based on duration of each stage. In response to receiving the selection operation on the first virtual object in the virtual object selection area, the character image of the first virtual object is displayed at a position corresponding to the selection operation on the current stage progress bar. The selection operation may be at least one of a tap operation, a double tap operation, a sliding operation, a hover operation, a touch operation input through an external device, or the like.

In another embodiment, in response to receiving the selection operation on the first virtual object in the virtual object selection area, character level information of the first virtual object is obtained; the character image of the first virtual object is determined based on the character level information of the first virtual object; and the character image of the first virtual object is displayed on the stage progress bar.

In some embodiments, in the current stage, there are a plurality of selection operations based on the candidate virtual object. Based on a selection operation on the at least one candidate virtual object in the virtual object selection area, a character image corresponding to the at least one candidate virtual object is displayed on a stage progress bar corresponding to the current stage based on selection timing of the virtual object. In other words, based on selection timing corresponding to selection operations on a plurality of virtual objects, character images are displayed in sequence in the stage progress bar, so that object selection information in the battle can be fed back in the stage progress bar, thereby improving an information indication capability.

The character image may be implemented as a two-dimensional image, or may be implemented as a three-dimensional image, or may be implemented as interspersed application of the two-dimensional image and the three-dimensional image. This is not limited in this application.

In the foregoing process, the character image of the first virtual object may be displayed on an outer side of the current stage progress bar or on an inner side of the current stage progress bar. This is not limited in this application.

In another embodiment, the stage progress bar includes a stage pointer; and a moving process of the stage pointer in the stage progress bar is configured for indicating the updating process of the stage progress bar, in other words, indicating progress of the current stage. In the updating process of the stage progress bar corresponding to the game round, in response to receiving the selection operation on the first virtual object, the updating process of the stage progress bar is displayed by using the character image of the first virtual object as the stage pointer. For example, in an i^{th} stage of the game round, a selection operation on a virtual object a is received at a first moment, and a default stage pointer is replaced with a character image of the virtual object a, to advance an update animation of the stage progress bar; and a selection operation on a virtual object b is received at a second moment, and the default stage pointer is replaced with a character image of the virtual object b, to advance an update animation of the stage progress bar. In other words, the stage pointer is added to the stage progress bar, and the character image of the virtual object is displayed in the stage progress bar in the form of the stage pointer based on the selection operation on the virtual object, thereby enriching message display content, and improving an information indication capability of the progress bar.

In some embodiments, the selection operation may be at least one of a game selection operation, a locking operation, or a game preparation selection operation.

Based on a game selection operation on the first virtual object, the character image corresponding to the first virtual object is displayed at the position corresponding to the current stage progress on the stage progress bar, the game selection operation being configured for indicating to select the first virtual object to participate in a game process of the virtual game. As shown in FIG. 7, a game interface 700 is displayed, and a stage progress bar 710 and a virtual object selection area 720 are displayed in the game interface 700, and at least one candidate virtual object (a candidate virtual object A to a candidate virtual object D) is displayed in the virtual object selection area 720. In response to receiving a selection operation on a virtual object B730 in the virtual object selection area 720, a character image of the virtual object B730 is displayed in a game preparation area and at a specified position 740 in the stage progress bar 710. Three character images are further displayed in the stage progress bar 710. The three character images may be configured for indicating virtual objects selected in the current stage, or may be configured for indicating virtual objects selected in a previous stage.

Based on a locking operation on the first virtual object, the character image corresponding to the first virtual object is displayed at the position corresponding to the current stage progress on the stage progress bar, the locking operation being configured for indicating to perform position locking on a target candidate virtual object in the virtual object selection area in the current stage. After the position locking, when the virtual object selection area is displayed in the next round, the target candidate virtual object is still displayed at an original display position. For example, the virtual object selection area includes three candidate display positions, in other words, three candidate virtual objects are displayed in one round. In the game round, a locking operation on a candidate virtual object displayed at a candidate display position 2 is received, and a locking mark is added to the candidate display position 2. When the player refreshes the candidate virtual object displayed in the virtual object selection area in the round, the candidate virtual object locked at the candidate display position 2 is always in an unchanged state. Even when the next round is entered, the locked candidate virtual object is still displayed at the candidate display position 2 in the virtual object selection area. In other words, based on a different operation type of the selection operation, the character image of the selected virtual object is fed back in the stage progress bar for display, thereby enriching an amount of information indicated by the progress bar.

Based on a game preparation selection operation on the first virtual object, the character image corresponding to the first virtual object is displayed at the position corresponding to the current stage progress on the stage progress bar, the game preparation selection operation being configured for indicating to display the first virtual object in the game preparation area, where the game preparation area includes at least one game preparation virtual object, and the game preparation virtual object is configured for indicating a virtual object that the player is about to use in a subsequent game stage.

In some embodiments, after the virtual object is selected, there may also be a removal operation on the virtual object. The removal operation may be a selling operation, a gift operation, or an operation of putting back to a virtual object refresh library. This is not limited in this application. The selling operation is configured for indicating the player to sell the virtual object, and obtain an equivalent virtual exchange resource, where the virtual exchange resource is configured for purchasing another virtual object or virtual equipment. In some embodiments, after the selling operation is performed, the quantity of times that the virtual object appears in the battle is reduced by one. For example, in the battle, a quantity of times that the virtual object a may appear is 10, and after the player sells the virtual object, all players in the battle can only see the virtual object 9 times in a subsequent operation process. The gift operation is configured for indicating a player a to give a virtual object owned by the player a to a player b in the form of a gift, and the player a and the player b belong to the same team. The operation of putting back to a virtual object refresh library is configured for indicating to put the virtual object back to the virtual object refresh library, and rejoin a random display queue, so that the virtual object is displayed in the virtual object selection area.

In an embodiment, in response to receiving a removal operation on the first virtual object, a deletion mark is added to the character image of the first virtual object displayed in the current stage progress bar in the updating process of the stage progress bar corresponding to the game round. Methods of adding the deletion mark include, but are not limited to, the following manners. In other words, if the removal operation on the virtual object is received, the deletion mark of the virtual object is correspondingly added in the stage progress bar, so that content displayed in the stage progress bar matches an operation of the user, thereby improving accuracy of information indication.

In a first method, the character image in the current stage progress bar is displayed in a hidden manner in response to receiving the removal operation on the first virtual object. To be specific, the character image displayed in the stage progress bar is directly switched from a display state to a hidden state, but the character image corresponding to this operation node still exists in battle data correspondingly stored in a target application.

In a second method, the character image in the current stage progress bar is deleted in response to receiving the removal operation on the first virtual object. To be specific, the character image displayed in the stage progress bar is directly deleted, and the character image corresponding to the operation node in the battle data correspondingly stored in the target application is deleted.

In a third method, a transparency reduction animation corresponding to the character image in the current stage progress bar is played in response to receiving the removal operation on the first virtual object. To be specific, display transparency of the character image displayed in the stage progress bar is adjusted when the removal operation on the first virtual object is received. For example, before the removal operation, a transparency value corresponding to the character image of the first virtual object is 0%; and after the removal operation is received, the transparency value corresponding to the character image is increased from 0% to a transparency value of 80%. A process of reducing the transparency is the transparency reduction animation. In some embodiments, the transparency reduction animation may be set by a developer, or may be set by the player, and a final transparency value may also be independently set based on an actual requirement.

In a fourth manner, the character image is replaced with a preset image in response to receiving the removal operation on the first virtual object. The preset image may also be an image having an association relationship with the first virtual object, or may be an image unrelated to the first virtual object. For example, the preset image is implemented as a character image of a second virtual object with an “X”; or the preset image may be implemented as a deleted image. This is not limited in this application.

For example, as shown in FIG. 7, with progression of the current stage, a game interface 750 is displayed; in response to receiving a removal operation (a selling operation) on the virtual object B730, the character image of the virtual object B730 is deleted from the game preparation area, and a deletion mark, which is specifically an identifier 760 in FIG. 7, is added to the character image of the virtual object B730 originally displayed in the stage progress bar 710.

In another embodiment, a removal operation on a second virtual object is received, and a character image of the second virtual object at the position corresponding to the current stage progress is displayed, the character image of the second virtual object being attached with a deletion mark, and the second virtual object being a virtual object obtained before the game round. For example, the player removes the virtual object a in the current stage, and a two-dimensional character image of the virtual object a is displayed at a position corresponding to the performed removal operation on the stage progress bar, where a deletion mark “X” is displayed on the two-dimensional character image. In other words, by performing the removal operation on the virtual object, a plurality of different types of manners are provided for adding the deletion mark to the virtual object in the stage progress bar, thereby enriching animation display content.

In another embodiment, countdown information corresponding to duration of the current stage is also displayed around the stage progress bar when the stage progress bar is displayed.

In another embodiment, early warning information is displayed in the game interface in response to preset progress duration being left in stage progress corresponding to each stage in the game round, the early warning information being configured for indicating that the current stage is about to end. The preset progress duration is set based on actual duration of a game stage, for example, set to be 5 s. The early warning information may be implemented as at least one of image information, text information, countdown information, dynamic effect information, voice information, or a vibration reminder. For example, when there are 5 s remaining in this stage, a prompt shadow dynamic effect is displayed on a peripheral side of a screen. The prompt shadow dynamic effect is scaled and played at a preset frequency, and is accompanied by a vibration prompt. In other words, when the stage is about to end, the early warning information is displayed, so that the user can be timely reminded of a current progress status.

In another embodiment, the stage progress bar is displayed at a first position in the game interface; a drag operation on the stage progress bar is received, the drag operation being configured for indicating to drag the stage progress bar from the first position to a second position in the game interface; and displaying of the stage progress bar is switched to displaying of a countdown identifier at the second position based on the drag operation, a timing status in the countdown identifier being consistent with the stage progress.

In this embodiment, when the drag operation on the stage progress bar is received, the stage progress bar is dragged from the first position to the second position, and the displaying of the stage progress bar is switched to the displaying of the corresponding countdown identifier at the second position, to display stage progress in the current battle by replacing stage adjustment with a countdown manner. In other words, the stage progress bar is dragged to different positions, and different identifiers are used to display the current stage progress, thereby enriching content information indicated by the progress bar.

In summary, according to the method for displaying an interface for a virtual game provided in the embodiments of this application, during progress of a turn-based virtual game, progress bars corresponding to two stages with adjacent timing in a single round indicate game progress in opposite update directions. Accordingly, remaining time of a specific stage in a game round can be clearly expressed, and progress bars of stages are smoothly connected, so that game experience of a user is enhanced when an information transmission rate of the progress bar is improved.

In the embodiments of this application, a corresponding character image is displayed in the progress bar based on a selection operation by a player on a virtual object, to remind the user of all selection operations in the game round, thereby enriching game information included in the progress bar, and improving human-computer interaction efficiency.

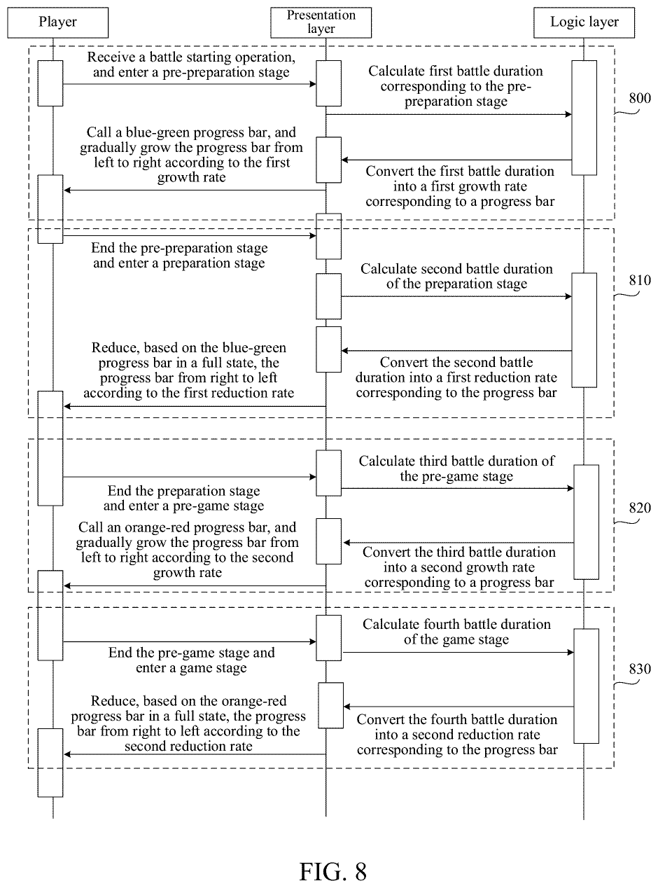

FIG. 8 shows an method for displaying an interface for a virtual game according to an embodiment of this application. In this embodiment, a specific recognition detection process of each stage in a target round is described. An example in which the method is applied to the terminal shown in FIG. 1 is used for description, and interaction parties include a player, a presentation layer, and a logic layer. The method includes the following operations:

Operation 800: Enter a pre-preparation stage.

In some embodiments, the player starts the virtual game; and the presentation layer receives a game starting operation, and enters the pre-preparation stage. The logic layer calculates first game duration corresponding to the pre-preparation stage, and converts the first game duration into a first growth rate corresponding to a progress bar; and the presentation layer calls a blue-green progress bar and displays the progress bar at the top of a game interface, and displays gradual growth of the progress bar from left to right according to the first growth rate.

Operation 810: Enter a preparation stage.

The pre-preparation stage ends and the preparation stage is entered. The logic layer calculates second game duration of the preparation stage, and converts the second game duration into a first reduction rate corresponding to the progress bar; and the presentation layer reduces, based on the blue-green progress bar in a full state, the progress bar from right to left according to the first reduction rate.

Operation 820: Enter a pre-game stage.

The preparation stage ends and the pre-game stage is entered. The logic layer calculates third game duration of the pre-game stage, and converts the third game duration into a second growth rate corresponding to a progress bar; and the presentation layer calls an orange-red progress bar and displays the progress bar at the top of the game interface, and gradually grows the progress bar from left to right according to the second growth rate.

Operation 830: Enter a game stage.

The pre-game stage ends and the game stage is entered. The logic layer calculates fourth game duration of the game stage, and converts the fourth game duration into a second reduction rate corresponding to the progress bar; and the presentation layer reduces, based on the orange-red progress bar in a full state, the progress bar from right to left according to the second reduction rate. In summary, according to the method for displaying an interface for a virtual game provided in the embodiments of this application, during progress of a turn-based virtual game, progress bars corresponding to two stages with adjacent timing in a single round indicate game progress in opposite update directions. Accordingly, remaining time of a specific stage in a game round can be clearly expressed, and progress bars of stages are smoothly connected, so that game experience of a user is enhanced when an information transmission rate of the progress bar is improved.

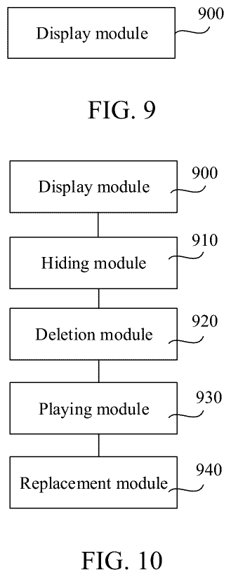

FIG. 9 is a block diagram of an interface display apparatus for a virtual game according to an embodiment of this application. The apparatus has a function of implementing the foregoing method examples, and the function may be implemented by hardware or may be implemented by hardware executing corresponding software. The apparatus may include:
a display module 900, configured to display a game interface corresponding to a turn-based virtual game, the turn-based virtual game including a plurality of rounds, the round including a plurality of stages, and the game interface including a stage progress bar;
the display module 900 being further configured to display, in an i^{th} stage of a game round, a first update animation of the stage progress bar in a first update direction based on stage progress of the i^{th} stage, i being a positive integer, and i being less than a quantity of stages of the game round; and
the display module 900 being further configured to display, in an (i+1)^{th} stage of the game round based on an update result of the stage progress bar in the i^{th} stage, a second update animation of the stage progress bar in a second update direction based on stage progress of the (i+1)^{th} stage, the first update direction and the second update direction being two opposite directions.

In an embodiment, the plurality of stages are divided into at least two stage groups, each stage group includes at least two stages, and the at least two stages include a preparatory stage and an execution stage with adjacent timing;
the display module 900 is further configured to display, based on stage progress of the preparatory stage, the first update animation of the stage progress bar in a growth direction of filling a progress bar element in the stage progress bar in the preparatory stage; and
the display module 900 is further configured to display, based on stage progress of the execution stage, the second update animation of the stage progress bar in a direction of reducing the progress bar element in the stage progress bar by using a fill result of the stage progress bar in the preparatory stage as update starting progress in the execution stage.

In an embodiment, the display module 900 is further configured to: display, based on an updating process of a stage progress bar corresponding to a first stage group, an update animation corresponding to a stage progress bar in a first display form; and
display, based on an updating process of a stage progress bar corresponding to a second stage group, an update animation corresponding to a stage progress bar in a second display form.

In an embodiment, the display module 900 is further configured to display, based on a selection operation on a first virtual object in a virtual object selection area, a character image corresponding to the first virtual object at a position corresponding to current stage progress on the stage progress bar in an updating process of the stage progress bar corresponding to the game round.

In an embodiment, the display module 900 is further configured to: display, based on a game selection operation on the first virtual object, the character image corresponding to the first virtual object at the position corresponding to the current stage progress on the stage progress bar, the game selection operation being configured for indicating to select the first virtual object to participate in a game process of the virtual game; or
display, based on a locking operation on the first virtual object, the character image corresponding to the first virtual object at the position corresponding to the current stage progress on the stage progress bar.

In an embodiment, the display module 900 is further configured to add, in response to receiving a removal operation on the first virtual object, a deletion mark to the character image of the first virtual object displayed in the current stage progress bar in the updating process of the stage progress bar corresponding to the game round; or
the display module 900 is further configured to: receive a removal operation on a second virtual object, and display a character image of the second virtual object at the position corresponding to the current stage progress, the character image of the second virtual object being attached with a deletion mark, and the second virtual object being a virtual object obtained before the game round.

In an embodiment, as shown in FIG. 10, the apparatus further includes a hiding module 910, configured to display the character image in the current stage progress bar in a hidden manner in response to receiving the removal operation on the first virtual object;
a deletion module 920, configured to delete the character image in the current stage progress bar in response to receiving the removal operation on the first virtual object;
a playing module 930, configured to play a transparency reduction animation corresponding to the character image in the current stage progress bar in response to receiving the removal operation on the first virtual object; and
a replacement module 940, configured to replace the character image with a preset image in response to receiving the removal operation on the first virtual object.

In an embodiment, the display module 900 is further configured to display, based on a selection operation on at least one candidate virtual object in the virtual object selection area, a character image corresponding to the at least one candidate virtual object on a stage progress bar corresponding to a current stage based on selection timing of the virtual object in the updating process of the stage progress bar corresponding to the game round.

In an embodiment, the stage progress bar includes a stage pointer; and a moving process of the stage pointer in the stage progress bar is configured for indicating the updating process of the stage progress bar; and
the display module 900 is further configured to display, in response to receiving the selection operation on the first virtual object, the updating process of the stage progress bar by using the character image of the first virtual object as the stage pointer in the updating process of the stage progress bar corresponding to the game round.

In another embodiment, the display module 900 is further configured to display early warning information in the game interface in response to preset progress duration being left in stage progress corresponding to each stage in the game round, the early warning information being configured for indicating that the current stage is about to end.

In another embodiment, the stage progress bar is displayed at a first position in the game interface; and
the display module 900 is further configured to: receive a drag operation on the stage progress bar, the drag operation being configured for indicating to drag the stage progress bar from the first position to a second position in the game interface; and switch, based on the drag operation, displaying of the stage progress bar to displaying of a countdown identifier at the second position, a timing status in the countdown identifier being consistent with the stage progress.

In summary, according to the interface display apparatus for a virtual game provided in the embodiments of this application, during progress of a turn-based virtual game, progress bars corresponding to two stages with adjacent time sequence in a single round indicate game progress in opposite update directions. Accordingly, remaining time of a specific stage in a game round can be clearly expressed, and progress bars of stages are smoothly connected, so that game experience of a user is enhanced when an information transmission rate of the progress bar is improved.

According to the interface display apparatus for a virtual game provided in the foregoing embodiments, division into the foregoing functional modules is only described for exemplary purposes. In actual applications, the foregoing functions may be allocated to different functional modules according to specific requirements, which means that an internal structure of a device is divided into different functional modules, to complete a part or all of the functions described above. In addition, the interface display apparatus for a virtual game provided in the foregoing embodiments and the embodiments of the method for displaying an interface for a virtual game fall within the same conception. For details of a specific implementation process, refer to the method embodiments. Details are not described herein again.

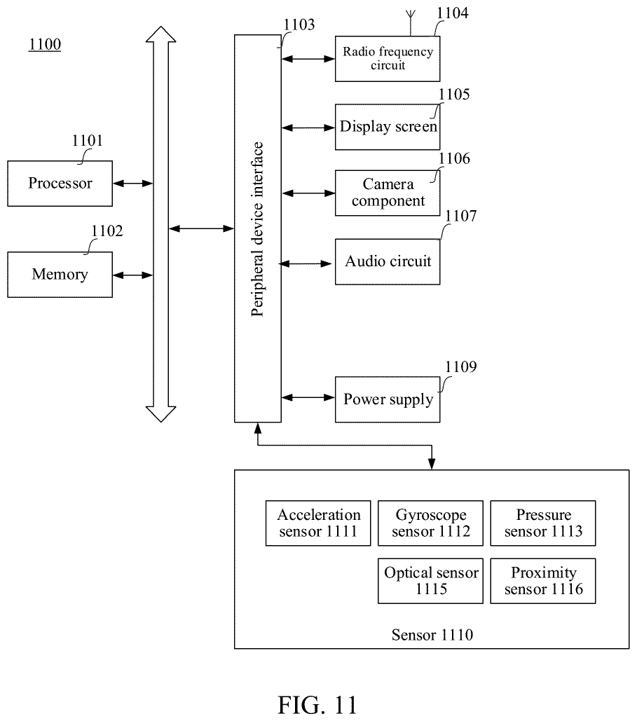

FIG. 11 is a block diagram of a structure of a terminal 1100 according to an embodiment of this application. The terminal 1100 may be a smartphone, a tablet computer, a moving picture experts group audio layer III (MP3) player, a moving picture experts group audio layer IV (MP4) player, a notebook computer, or a desktop computer. The terminal 1100 may also be referred to as another name such as a user device, a portable terminal, a laptop terminal, or a desktop terminal.

Generally, the terminal 1100 includes a processor 1101 and a memory 1102.

The processor 1101 may include one or more processing cores, such as a 4-core processor or an 8-core processor. The processor 1101 may be implemented in at least one hardware form of a digital signal processor (DSP), a field-programmable gate array (FPGA), and a programmable logic array (PLA). The processor 1101 may alternatively include a main processor and a coprocessor. The main processor is a processor configured to process data in an awake state, and is also referred to as a central processing unit (CPU). The coprocessor is a low power consumption processor configured to process the data in a standby state. In some embodiments, the processor 1101 may be integrated with a graphics processing unit (GPU). The GPU is configured to render and draw content that needs to be displayed on a display screen. In some embodiments, the processor 1101 may further include an artificial intelligence (AI) processor. The AI processor is configured to process a computing operation related to machine learning.

The memory 1102 may include one or more computer-readable storage media. The computer-readable storage medium may be non-transient. The memory 1102 may further include a high-speed random access memory and a non-volatile memory, such as one or more disk storage devices or flash storage devices. In some embodiments, the non-transient computer-readable storage medium in the memory 1102 is configured to store at least one instruction, the at least one instruction being configured to be executed by the processor 1101 to implement the virtual game-based method for displaying an interface provided in the method embodiments of this application.

In some embodiments, the terminal 1100 may further include: a peripheral device interface 1103 and at least one peripheral device. The processor 1101, the memory 1102, and the peripheral device interface 1103 may be connected through a bus or a signal cable. Each peripheral device may be connected to the peripheral device interface 1103 through a bus, a signal cable, or a circuit board. Specifically, the peripheral device includes at least one of a radio frequency (RF) circuit 1104, a display screen 1105, a camera component 1106, an audio circuit 1107, and a power supply 1109.

The peripheral device interface 1103 may be configured to connect the at least one peripheral device related to input/output (I/O) to the processor 1101 and the memory 1102. In some embodiments, the processor 1101, the memory 1102, and the peripheral device interface 1103 are integrated on the same chip or circuit board. In some other embodiments, any one or two of the processors 1101, the memory 1102, and the peripheral device interface 1103 may be implemented on a single chip or circuit board. This is not limited in this embodiment.

The RF circuit 1104 is configured to receive and transmit a radio frequency (RF) signal, also referred to as an electromagnetic signal. The RF circuit 1104 communicates with a communication network and other communication devices through the electromagnetic signal. The RF circuit 1104 converts an electric signal into an electromagnetic signal for transmission, or converts a received electromagnetic signal into an electric signal.

The display screen 1105 is configured to display a user interface (UI). The UI may include a graph, a text, an icon, a video, and any combination thereof. When the display screen 1105 is a touch display screen, the display screen 1105 further has a capability of acquiring a touch signal on or above the surface of the display screen 1105. The touch signal may be inputted to the processor 1101 as a control signal for processing. In this case, the display screen 1105 may be further configured to provide a virtual button and/or a virtual keyboard that are/is also referred to as a soft button and/or a soft keyboard. In some embodiments, there may be one display screen 1105, disposed on a front panel of the terminal 1100. In some other embodiments, there may be at least two display screens 1105, respectively disposed on different surfaces of the terminal 1100 or designed in a foldable shape. In still some other embodiments, the display screen 1105 may be a flexible display screen, disposed on a curved surface or a folded surface of the terminal 1100. Even, the display screen 1105 may be further set in a non-rectangular irregular pattern, namely, a special-shaped screen. The display screen 1105 may be prepared by using a material such as a liquid crystal display (LCD) or an organic light-emitting diode (OLED).

The camera component 1106 is configured to acquire an image or a video. In some embodiments, the camera component 1106 includes a front camera and a rear camera. Generally, the front camera is disposed on the front panel of the terminal, and the rear camera is disposed on the back surface of the terminal.

The audio circuit 1107 may include a microphone and a speaker. The microphone is configured to: acquire sound waves of a user and an environment, and convert the sound wave into an electrical signal, to input the electrical signal to the processor 1101 for processing, or input the electrical signal to the RF circuit 1104 for implementing voice communication. For the purpose of stereo acquisition or noise reduction, there may be a plurality of microphones, respectively disposed at different parts of the terminal 1100. The microphone may further be an array microphone or an omni-directional acquisition type microphone. The speaker is configured to convert an electric signal from the processor 1101 or the RF circuit 1104 into a sound wave. The speaker may be a conventional thin-film speaker, or may be a piezoelectric ceramic speaker. When the speaker is the piezoelectric ceramic speaker, the speaker can convert an electric signal into an acoustic wave audible to a human being, and can also convert an electric signal into an acoustic wave inaudible to a human being for ranging and other purposes. In some embodiments, the audio circuit 1107 may further include an earphone jack.

The power supply 1109 is configured to supply power to components on the terminal 1100. The power supply 1109 may be an alternating current, a direct current, a primary battery, or a rechargeable battery. When the power supply 1109 includes the rechargeable battery, the rechargeable battery may be a wired rechargeable battery or a wireless rechargeable battery. The wired rechargeable battery is a battery charged through a wired circuit, and the wireless rechargeable battery is a battery charged through a wireless coil. The rechargeable battery may be further configured to support a fast charging technology.

In some embodiments, the terminal 1100 further includes one or more sensors 1110. The one or more sensors 1110 include, but are not limited to: an acceleration sensor 1111, a gyroscope sensor 1112, a pressure sensor 1113, an optical sensor 1115, and a proximity sensor 1116.

The acceleration sensor 1111 may detect a magnitude of acceleration on three coordinate axes of a coordinate system established with the terminal 1100. For example, the acceleration sensor 1111 may be configured to detect components of gravity acceleration on the three coordinate axes. The processor 1101 may control, based on a gravity acceleration signal acquired by the acceleration sensor 1111, the touch display screen 1105 to display the UI in a landscape view or a portrait view. The acceleration sensor 1011 may be further configured to acquire motion data of a game or a user.

The gyroscope sensor 1112 may detect a body direction and a rotation angle of the terminal 1100. The gyroscope sensor 1112 may cooperate with the acceleration sensor 1111 to acquire a 3D action by the user on the terminal 1100. The processor 1101 may implement the following functions based on data acquired by the gyroscope sensor 1112: motion sensing (for example, changing the UI based on a tilt operation by the user), image stabilization during shooting, game control, and inertial navigation.

The pressure sensor 1113 may be disposed at a side frame of the terminal 1100 and/or a lower layer of the touch display screen 1105. When the pressure sensor 1113 is disposed at the side frame of the terminal 1100, a holding signal of the user on the terminal 1100 may be detected. The processor 1101 performs left and right hand recognition or a quick operation based on the holding signal acquired by the pressure sensor 1113. When the pressure sensor 1113 is disposed on the low layer of the touch display screen 1105, the processor 1101 controls an operable control on the UI based on a pressure operation by the user on the touch display screen 1105. The operable control includes at least one of a button control, a scroll-bar control, an icon control, or a menu control.

The optical sensor 1115 is configured to acquire ambient light intensity. In one embodiment, the processor 1101 may control display brightness of the touch display screen 1105 based on the ambient light intensity acquired by the optical sensor 1115. Specifically, when the ambient light intensity is high, the display brightness of the touch display screen 1105 is increased. When the ambient light intensity is low, the display brightness of the touch display screen 1105 is decreased. In another embodiment, the processor 1101 may further dynamically adjust a camera parameter of the camera component 1106 based on the ambient light intensity acquired by the optical sensor 1115.

The proximity sensor 1116, also referred to as a distance sensor, is generally disposed on the front panel of the terminal 1100. The proximity sensor 1116 is configured to acquire a distance between a user and a front surface of the terminal 1100. In one embodiment, when the proximity sensor 1116 detects that the distance between the user and the front surface of the terminal 1100 gradually becomes small, the touch display screen 1105 is controlled by the processor 1101 to switch from a screen-on state to a screen-off state. When the proximity sensor 1116 detects that the distance between the user and the front surface of the terminal 1100 gradually becomes large, the touch display screen 1105 is controlled by the processor 1101 to switch from the screen-off state to the screen-on state.

A person skilled in the art may understand that the structure shown in FIG. 11 constitutes no limitation on the terminal 1100, and the terminal may include more or fewer components than those shown in the figure, or some components may be combined, or a different component arrangement may be used.

A person of ordinary skill in the art may understand that a part or all of the operations of the methods in the foregoing embodiments may be implemented by a program instructing relevant hardware. The program may be stored in a computer-readable storage medium. The computer-readable storage medium may be the computer-readable storage medium included in the memory in the foregoing embodiment, or may be a computer-readable storage medium that exists independently and that is not assembled in a terminal. The computer-readable storage medium stores at least one instruction, at least one program, and a code set or an instruction set, and the at least one instruction, the at least one program, and the code set or the instruction set are loaded and executed by a processor to implement the virtual game-based method for displaying an interface described in any one of the foregoing embodiments.

In some embodiments, the computer-readable storage medium may include: a read-only memory (ROM), a random access memory (RAM), a solid-state drive (SSD), an optical disc, or the like. The RAM may include a resistance random access memory (ReRAM) and a dynamic random access memory (DRAM). The sequence numbers of the foregoing embodiments of this application are merely for a description purpose, but do not imply the preference among the embodiments.

What is claimed is:

1. A method for displaying an interface for a virtual game, executed by a terminal, and comprising:
displaying a game interface corresponding to a turn-based virtual game, the turn-based virtual game comprising a plurality of rounds, each round comprising a plurality of stages, and the game interface comprising a stage progress bar;
displaying, in an i^{th} stage of a game round, a first update animation of the stage progress bar in a first update direction based on stage progress of the i^{th} stage, i being a positive integer, and i being less than a quantity of stages of the game round; and
displaying, in an (i+1)^{th} stage of the game round based on an update result of the stage progress bar in the i^{th} stage, a second update animation of the stage progress bar in a second update direction based on stage progress of the (i+1)^{th} stage, the first update direction and the second update direction being two opposite directions.

2. The method according to claim 1, wherein the plurality of stages is divided into at least two stage groups, each stage group comprises at least two stages, and the at least two stages comprise a preparatory stage and an execution stage with an adjacent timing sequence;
the displaying, in an i^{th} stage of a game round, a first update animation of the stage progress bar in a first update direction based on stage progress of the i^{th} stage comprises:
displaying, based on stage progress of the preparatory stage, the first update animation of the stage progress bar in a growth direction of filling a progress bar element in the stage progress bar in the preparatory stage; and
the displaying, in an (i+1)^{th} stage of the game round based on an update result of the stage progress bar in the i^{th} stage, a second update animation of the stage progress bar in a second update direction based on stage progress of the (i+1)^{th} stage comprises:
displaying, based on stage progress of the execution stage, the second update animation of the stage progress bar in a direction of reducing the progress bar element in the stage progress bar by using a fill result of the stage progress bar in the preparatory stage as updates starting progress in the execution stage.

3. The method according to claim 2, wherein the at least two stage groups comprise a first stage group and a second stage group; and
the method further comprises:
displaying, based on an updating process of a stage progress bar corresponding to the first stage group, an update animation corresponding to a stage progress bar in a first display form; and
displaying, based on an updating process of a stage progress bar corresponding to the second stage group, an update animation corresponding to a stage progress bar in a second display form.

4. The method according to claim 1, wherein a virtual object selection area is displayed in the game interface, and the virtual object selection area comprises at least one candidate virtual object; and
the method further comprises:
displaying, based on a selection operation on a first virtual object in the virtual object selection area, a character image corresponding to the first virtual object at a position corresponding to current stage progress on the stage progress bar in an updating process of the stage progress bar corresponding to the game round.

5. The method according to claim 4, wherein the displaying, based on a selection operation on a first virtual object in the virtual object selection area, a character image corresponding to the first virtual object at a position corresponding to current stage progress on the stage progress bar comprises:
displaying, based on a game selection operation on the first virtual object, the character image corresponding to the first virtual object at the position corresponding to the current stage progress on the stage progress bar, the game selection operation being configured for indicating to select the first virtual object to participate in a game process of the virtual game; or
displaying, based on a locking operation on the first virtual object, the character image corresponding to the first virtual object at the position corresponding to the current stage progress on the stage progress bar.

6. The method according to claim 5, wherein after the displaying, based on a selection operation on a first virtual object in the virtual object selection area, a character image corresponding to the first virtual object at a position corresponding to current stage progress on the stage progress bar, the method further comprises:
adding, in response to receiving a removal operation on the first virtual object, a deletion mark to the character image of the first virtual object displayed in the current stage progress bar in the updating process of the stage progress bar corresponding to the game round; or
receiving a removal operation on a second virtual object, and displaying a character image of the second virtual object at the position corresponding to the current stage progress, the character image of the second virtual object being attached with a deletion mark, and the second virtual object being a virtual object obtained before the game round.

7. The method according to claim 6, wherein the adding, in response to receiving a removal operation on the first virtual object, a deletion mark to the character image of the first virtual object displayed in the current stage progress bar comprises:
displaying the character image in the current stage progress bar in a hidden manner in response to receiving the removal operation on the first virtual object; or
deleting the character image in the current stage progress bar in response to receiving the removal operation on the first virtual object; or
playing a transparency reduction animation corresponding to the character image in the current stage progress bar in response to receiving the removal operation on the first virtual object; or
replacing the character image with a preset image in response to receiving the removal operation on the first virtual object.

8. The method according to claim 5, wherein the displaying, based on a selection operation on a first virtual object in the virtual object selection area, a character image corresponding to the first virtual object at a position corresponding to current stage progress on the stage progress bar in an updating process of the stage progress bar corresponding to the game round comprises:
displaying, based on a selection operation on the at least one candidate virtual object in the virtual object selection area, a character image corresponding to the at least one candidate virtual object on a stage progress bar corresponding to a current stage based on selection timing of the virtual object in the updating process of the stage progress bar corresponding to the game round.

9. The method according to claim 5, wherein the stage progress bar comprises a stage pointer; and a moving process of the stage pointer in the stage progress bar is configured for indicating the updating process of the stage progress bar; and
the displaying, based on a selection operation on a first virtual object in the virtual object selection area, a character image corresponding to the first virtual object at a position corresponding to current stage progress on the stage progress bar in an updating process of the stage progress bar corresponding to the game round comprises:
displaying, in response to receiving the selection operation on the first virtual object, the updating process of the stage progress bar by using the character image of the first virtual object as the stage pointer in the updating process of the stage progress bar corresponding to the game round.

10. The method according to claim 1, further comprising:
displaying early warning information in the game interface in response to preset progress duration being left in stage progress corresponding to each stage in the game round, the early warning information being configured for indicating that the current stage is about to end.

11. The method according to claim 1, wherein the stage progress bar is displayed at a first position in the game interface; and
after the displaying a first update animation of the stage progress bar in a first update direction based on stage progress of the i^{th} stage, the method further comprises:
receiving a drag operation on the stage progress bar, the drag operation being configured for indicating to drag the stage progress bar from the first position to a second position in the game interface; and
switching, based on the drag operation, displaying of the stage progress bar to displaying of a countdown identifier at the second position, a timing status in the countdown identifier being consistent with the stage progress.

12. A computer device, comprising a processor and a memory, the memory having at least one program stored therein, and the at least one program being loaded and executed by the processor, to implement a method for displaying an interface for a virtual game, executed by a terminal, comprising:
displaying a game interface corresponding to a turn-based virtual game, the turn-based virtual game comprising a plurality of rounds, each round comprising a plurality of stages, and the game interface comprising a stage progress bar;
displaying, in an i^{th} stage of a game round, a first update animation of the stage progress bar in a first update direction based on stage progress of the i^{th} stage, i being a positive integer, and i being less than a quantity of stages of the game round; and
displaying, in an (i+1)^{th} stage of the game round based on an update result of the stage progress bar in the i^{th} stage, a second update animation of the stage progress bar in a second update direction based on stage progress of the (i+1)^{th} stage, the first update direction and the second update direction being two opposite directions.

13. The computer device according to claim 12, wherein the plurality of stages is divided into at least two stage groups, each stage group comprises at least two stages, and the at least two stages comprise a preparatory stage and an execution stage with an adjacent timing sequence;
the displaying, in an i^{th} stage of a game round, a first update animation of the stage progress bar in a first update direction based on stage progress of the i^{th} stage comprises:
displaying, based on stage progress of the preparatory stage, the first update animation of the stage progress bar in a growth direction of filling a progress bar element in the stage progress bar in the preparatory stage; and
the displaying, in an (i+1)^{th} stage of the game round based on an update result of the stage progress bar in the i^{th} stage, a second update animation of the stage progress bar in a second update direction based on stage progress of the (i+1)^{th} stage comprises:
displaying, based on stage progress of the execution stage, the second update animation of the stage progress bar in a direction of reducing the progress bar element in the stage progress bar by using a fill result of the stage progress bar in the preparatory stage as updates starting progress in the execution stage.

14. The computer device according to claim 13, wherein the at least two stage groups comprise a first stage group and a second stage group; and
the method further comprises:
displaying, based on an updating process of a stage progress bar corresponding to the first stage group, an update animation corresponding to a stage progress bar in a first display form; and
displaying, based on an updating process of a stage progress bar corresponding to the second stage group, an update animation corresponding to a stage progress bar in a second display form.

15. The computer device according to claim 12, wherein a virtual object selection area is displayed in the game interface, and the virtual object selection area comprises at least one candidate virtual object; and
the method further comprises:
displaying, based on a selection operation on a first virtual object in the virtual object selection area, a character image corresponding to the first virtual object at a position corresponding to current stage progress on the stage progress bar in an updating process of the stage progress bar corresponding to the game round.

16. The computer device according to claim 15, wherein the displaying, based on a selection operation on a first virtual object in the virtual object selection area, a character image corresponding to the first virtual object at a position corresponding to current stage progress on the stage progress bar comprises:
displaying, based on a game selection operation on the first virtual object, the character image corresponding to the first virtual object at the position corresponding to the current stage progress on the stage progress bar, the game selection operation being configured for indicating to select the first virtual object to participate in a game process of the virtual game; or
displaying, based on a locking operation on the first virtual object, the character image corresponding to the first virtual object at the position corresponding to the current stage progress on the stage progress bar.

17. The computer device according to claim 16, wherein after the displaying, based on a selection operation on a first virtual object in the virtual object selection area, a character image corresponding to the first virtual object at a position corresponding to current stage progress on the stage progress bar, the method further comprises:
adding, in response to receiving a removal operation on the first virtual object, a deletion mark to the character image of the first virtual object displayed in the current stage progress bar in the updating process of the stage progress bar corresponding to the game round; or
receiving a removal operation on a second virtual object, and displaying a character image of the second virtual object at the position corresponding to the current stage progress, the character image of the second virtual object being attached with a deletion mark, and the second virtual object being a virtual object obtained before the game round.

18. The computer device according to claim 17, wherein the adding, in response to receiving a removal operation on the first virtual object, a deletion mark to the character image of the first virtual object displayed in the current stage progress bar comprises:
displaying the character image in the current stage progress bar in a hidden manner in response to receiving the removal operation on the first virtual object; or
deleting the character image in the current stage progress bar in response to receiving the removal operation on the first virtual object; or
playing a transparency reduction animation corresponding to the character image in the current stage progress bar in response to receiving the removal operation on the first virtual object; or
replacing the character image with a preset image in response to receiving the removal operation on the first virtual object.

19. The computer device according to claim 16, wherein the displaying, based on a selection operation on a first virtual object in the virtual object selection area, a character image corresponding to the first virtual object at a position corresponding to current stage progress on the stage progress bar in an updating process of the stage progress bar corresponding to the game round comprises:
displaying, based on a selection operation on the at least one candidate virtual object in the virtual object selection area, a character image corresponding to the at least one candidate virtual object on a stage progress bar corresponding to a current stage based on selection timing of the virtual object in the updating process of the stage progress bar corresponding to the game round.

20. A non-transitory computer-readable storage medium, having at least one program code stored therein, the program code being loaded and executed by a processor, to implement a method for displaying an interface for a virtual game, executed by a terminal, comprising:
displaying a game interface corresponding to a turn-based virtual game, the turn-based virtual game comprising a plurality of rounds, each round comprising a plurality of stages, and the game interface comprising a stage progress bar;
displaying, in an i^{th} stage of a game round, a first update animation of the stage progress bar in a first update direction based on stage progress of the i^{th} stage, i being a positive integer, and i being less than a quantity of stages of the game round; and
displaying, in an (i+1)^{th} stage of the game round based on an update result of the stage progress bar in the i^{th} stage, a second update animation of the stage progress bar in a second update direction based on stage progress of the (i+1)^{th} stage, the first update direction and the second update direction being two opposite directions.
